(19) United States
(12) Patent Application Publication
(10) Pub. No.: US 2017/0338674 A1
(43) Pub. Date: Nov. 23, 2017

(54) METHOD FOR CONTROLLING CHARGE STATES OF BATTERY CELLS CONNECTED IN SERIES AND ASSOCIATED CHARGE SYSTEM

(71) Applicant: Brocere Electronics company limited, New Taipei City (TW)

(72) Inventors: Chih-Hao Lai, Taipei City (TW); Jou-Hung Wang, Taipei City (TW)

(21) Appl. No.: 15/158,597

(22) Filed: May 19, 2016

(51) Int. Cl. H02J 7/00; H01M 10/42; H01M 10/48; H01M 10/44; H01M 10/46; H02J 7/34

(52) U.S. Cl. CPC H02J 7/0026; H01M 10/441; H01M 10/46; H02J 7/0014; H01M 10/4257; H01M 10/482; H01M 2010/4278; H02J 7/345; H01M 2010/4271

(57) ABSTRACT

A method for controlling charge states of a plurality of battery cells connected in series comprises: for a charge node of each battery cells, comparing a voltage of the charge node with a plurality of reference voltages to generate a comparison result, wherein the comparison result comprises a plurality of digital values, respectively; determining a charge state of each battery cell by calculating a difference between the comparison results of two charge nodes of two adjacent battery cells; and controlling charge currents supplied to the battery cells according the charge states of the battery cells, respectively.

### BACKGROUND OF THE INVENTION

### 1. Field of the Invention

The present invention relates to a charge system, and more particularly, to a method for programmable controlling charge states of battery cells connected in series.

### 2. Description of the Prior Art

Recently, new battery cells such as super-capacitor and ultra-capacitor are developed to make the battery cells have fast charging/discharging capability. However, when more than one battery cells are connected in series, the charging rates of these battery cells are much different due to the capacitance variation, and one or more battery cells may be over-charged while the other battery cells are not charged completely. The over-charged battery cells may generate heat and may be damaged.

To solve this problem, some prior techniques have complicated circuit design but still has low flexibility to control the tolerance of battery cell imbalance or some prior techniques use rectifier circuit to charge/discharge imbalance current directly which consumes much current.

### SUMMARY OF THE INVENTION

It is therefore an objective of the present invention to provide a method for controlling charge states of battery cells and associated charge system, which has a simple circuit structure, charge/discharge current reuse for lower current consumption, and higher flexibility to determine the imbalance tolerance, to solve the above-mentioned problems.

According to one embodiment of the present invention, a method for controlling charge states of a plurality of battery cells connected in series comprises: for a charge node of each battery cells, comparing a voltage of the charge node with a plurality of reference voltages to generate a comparison result, wherein the comparison result comprises a plurality of digital values, respectively; determining a charge state of each battery cell by calculating a difference between the comparison results of two charge nodes of two adjacent battery cells; and controlling charge currents supplied to the battery cells according the charge states of the battery cells, respectively.

According to another embodiment of the present invention, a charge system comprises a plurality of battery cells connected in series, a detecting circuit and a control circuit. The detecting circuit is coupled to the plurality of battery cells, wherein for a charge node of each battery cells, the detecting circuit compares a voltage of the charge node with a plurality of reference voltages to generate a comparison result, wherein the comparison result comprises a plurality of digital values, respectively; and the detecting circuit further determines a charge state of each battery cell by calculating a difference between the comparison results of two charge nodes of two adjacent battery cells; and the control circuit is coupled to the detecting circuit, and is arranged for controlling charge currents supplied to the battery cells according the charge states of the battery cells, respectively.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a charge system according to one embodiment of the present invention.

FIG. 2 is a diagram illustrating a charge system according to another embodiment of the present invention.

FIG. 3 is a diagram illustrating a charge system according to another embodiment of the present invention.

FIGS. 4-6 are diagrams illustrating the values of DV1 and DV2 and the corresponding charge state of the battery cell C2 according to one embodiment of the present invention.

FIG. 7 is a current use method applied to the charge system according to one embodiment of the present invention.

FIG. 8 is a current use method applied to the charge system according to another embodiment of the present invention.

FIG. 9 is a flowchart of a method for controlling charge states of a plurality of battery cells connected in series according to one embodiment of the present invention.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used and interpreted to mean “including but not a limit.” The terms “couple” and “couples” are intended to mean either an indirect or a direct electrical connection.

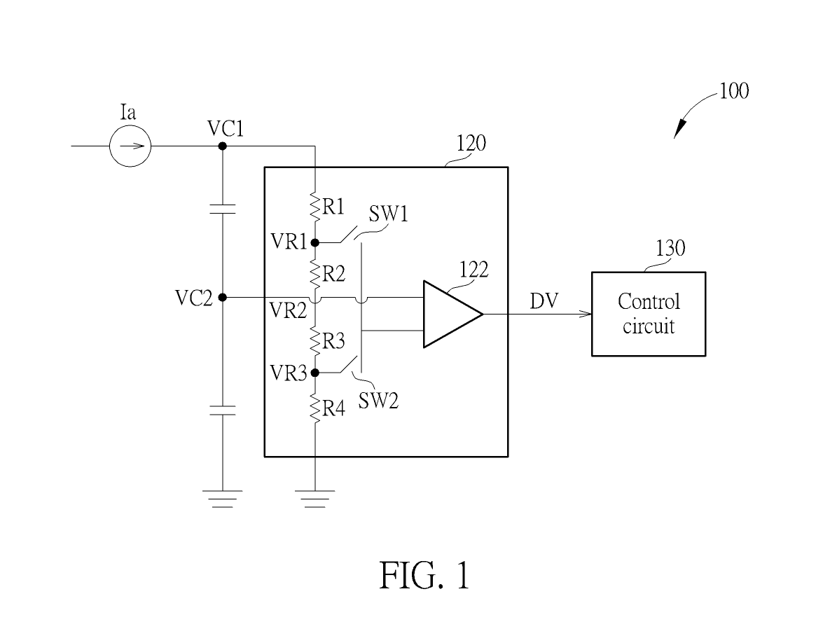

Please refer to FIG. 1, which is a diagram illustrating a charge system 100 according to one embodiment of the present invention. Referring to FIG. 1, the charge system 100 comprises two battery cells C1 and C2 connected in series, a detecting circuit 120 and a control circuit 130. In this embodiment, the two battery cells C1 and C2 may be super-capacitors or ultra-capacitors, and the detecting circuit 120 comprises four resistors R1-R4 having the same resistance, two switches SW1-SW2 and a comparator 122, where the four resistors R1-R4 are arranged to provide three reference voltages VR1-VR3.

In the operations of the charge system 100 shown in FIG. 1, when the battery cells C1 and C2 are charged by a supply current Ia, and the voltages at the charge nodes (i.e. VC1 and VC2) of the battery cells C1 and C2 are increased. When the voltage VC1 reaches a threshold voltage, which should be lower than a maximum voltage of the charge node, the detecting circuit 120 starts to detect the charge states of the battery cells C1 and C2 for further control. Regarding the operations of the detecting circuit 120, by controlling the states of the switches SW1 and SW2, the comparator 122 sequentially compares the voltage VC2 with the reference voltage VR1, and compares the voltage VC2 with the reference voltage VR3, to generate two comparison results DV, where each comparison result DV is a digital value.

Each of the battery cells C1 and C2 has its max over-charged voltage limitation, and the designer can obtain a tolerance factor to prevent the battery cells C1/C2 overcharged damage. For example, if the battery cell C2 is designed to be charged to 1V and the max overcharged voltage is 2V, the tolerance factor can be programmed to be a value such as “0.5” (50% tolerance) to make the voltage of the battery cell C2 less than 2V. In this embodiment, each of the battery cells C1 and C2 is required to set the tolerance factor for the following charge current control steps.

To protect the battery cells from being over-charged, variation of the voltage VC2 should be less than (VC1/2)*Ftol, where “Ftol” is the aforementioned tolerance factor, and in this embodiment the tolerance factor is “0.5”. By referring to the two comparison results DV outputted by the detecting circuit 120, states of the battery cells C1 and C2 can be determined. In this embodiment, when the comparison results DV indicate that VC2<VR1 and VC2<VR3, it is determined that the battery cells C1 and C2 are not over-charged; when the comparison result DV indicates that VC2<VR3 , it is determined that the battery cell C1 is over-charged (50% tolerance); and when the comparison result DV indicates that VC2<VR1, it is determined that the battery cell C2 is over-charged (50% tolerance).

After determining the charge states of the battery cells C1 and C2, the control circuit 130 may perform some compensation mechanisms to avoid or alleviate the over-charge situation of the battery cells C1 and C2, such as lowering the supply current Ia or providing additional current to the charge node of the battery cell C2.

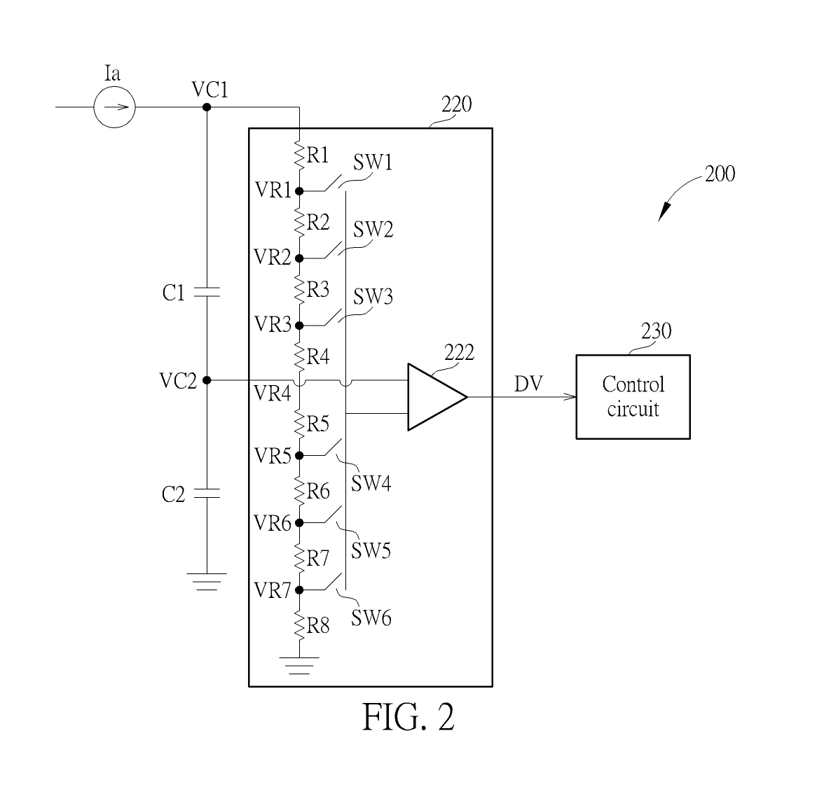

Please refer to FIG. 2, which is a diagram illustrating a charge system 200 according to another embodiment of the present invention. Referring to FIG. 2, the charge system 200 comprises two battery cells C1 and C2 connected in series, a detecting circuit 220 and a control circuit 230. In this embodiment, the two battery cells C1 and C2 may be super-capacitors and ultra-capacitors, and the detecting circuit 220 comprises eight resistors R1-R8 having the same resistance, six switches SW1-SW6 and a comparator 222, where the four resistors R1-R8 are arranged to provide seven reference voltages VR1-VR7.

In the operations of the charge system 200 shown in FIG. 2, when the battery cells C1 and C2 are charged by a supply current Ia, and the voltages at the charge nodes (i.e. VC1 and VC2) of the battery cells C1 and C2 are increased. When the voltage VC1 reaches a threshold voltage, which should be lower than a maximum voltage of the charge node, the detecting circuit 220 starts to detect the charge states of the battery cells C1 and C2 for further control. Regarding the operations of the detecting circuit 220, by controlling the states of the switches SW1-SW6, the comparator 222 sequentially compares the voltage VC2 with the reference voltages VR1-VR3 and VR5-VR7, to generate six comparison results DV, where each comparison result DV is a digital value.

To protect the battery cells from being over-charged, variation of the voltage VC2 should be less than (VC1/2)*Ftol, where “Ftol” is the aforementioned tolerance factor, and in this embodiment the tolerance factor is “0.25”. By referring to the six comparison results DV outputted by the detecting circuit 120, states of the battery cells C1 and C2 can be determined as follows:
No over-charge: VC2<VR3 and VC2>VR5;
C1 over-charge 25%: VC2<VR5 and VC2>VR6;
C1 over-charge 50%: VC2<VR6 and VC2>VR7;
C1 over-charge 75%: VC2<VR7;
C2 over-charge 25%: VC2>VR3 and VC2<VR2;
C2 over-charge 50%: VC2>VR2 and VC2<VR1;
C2 over-charge 75%: VC2>VR1.

After determining the charge states of the battery cells C1 and C2, the control circuit 230 may perform some compensation mechanisms to avoid or alleviate the over-charge situation of the battery cells C1 and C2, such as lowering the supply current Ia or providing additional current to the charge node of the battery cell C2.

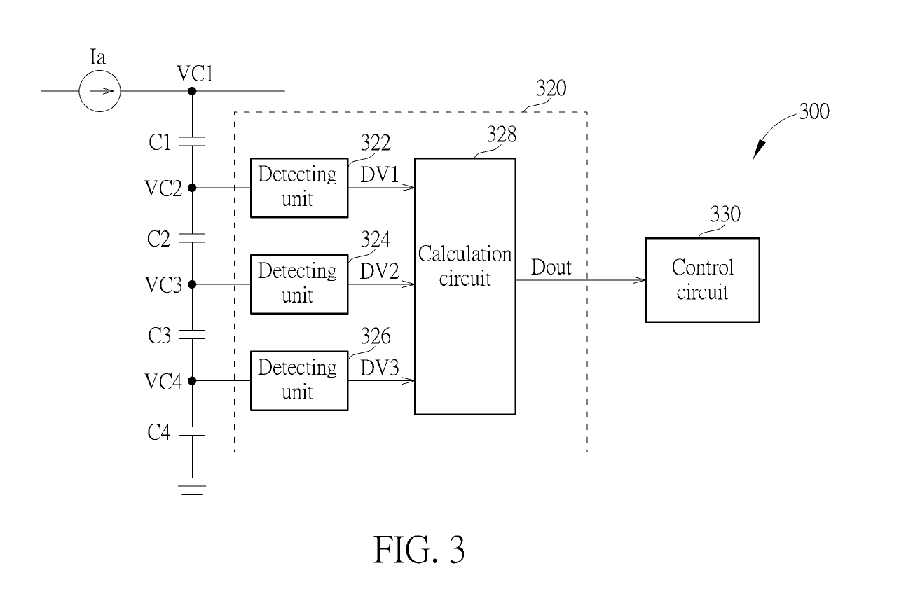

Please refer to FIG. 3, which is a diagram illustrating a charge system 300 according to another embodiment of the present invention. Referring to FIG. 3, the charge system 300 comprises four battery cells C1-C4 connected in series, a detecting circuit 320 and a control circuit 330. In this embodiment, the four battery cells C1-C4 may be super-capacitors and ultra-capacitors, and the detecting circuit 320 comprises three detecting units 322, 324 and 326, and a calculation unit 328. In this embodiment, each of the detecting units 322, 324 and 326 is implemented by the detecting circuit 220 shown in FIG. 2, that is the detecting unit 322 is arranged to compare the voltage VC2 of the charge node of the battery cell C2 with the reference voltages VR1-VR3 and VR5-VR7, to generate six comparison results DV; the detecting unit 324 is arranged to compare the voltage VC3 of the charge node of the battery cell C3 with the reference voltages VR1-VR3 and VR5-VR7, to generate six comparison results DV; and the detecting unit 326 is arranged to compare the voltage VC4 of the charge node of the battery cell C4 with the reference voltages VR1-VR3 and VR5-VR7, to generate six comparison results DV. In addition, in one embodiment, the aforementioned tolerance factors “Fol” for the voltages VC2, VC3 and VC4 of the charge nodes of the battery cells C2-C4 are programmable, and the tolerance factors “Fol” of the battery cells C2-C4 may be the same or different.

In the operations of the charge system 300 shown in FIG. 3, when the battery cells C1-C4 are charged by a supply current Ia, and the voltages at the charge nodes (i.e. VC1-VC4) of the battery cells C1-C4 are increased. When the voltage VC1 reaches a threshold voltage, which should be lower than a maximum voltage of the charge node, the detecting circuit 320 starts to detect the charge states of the battery cells C1-C4 for further control.

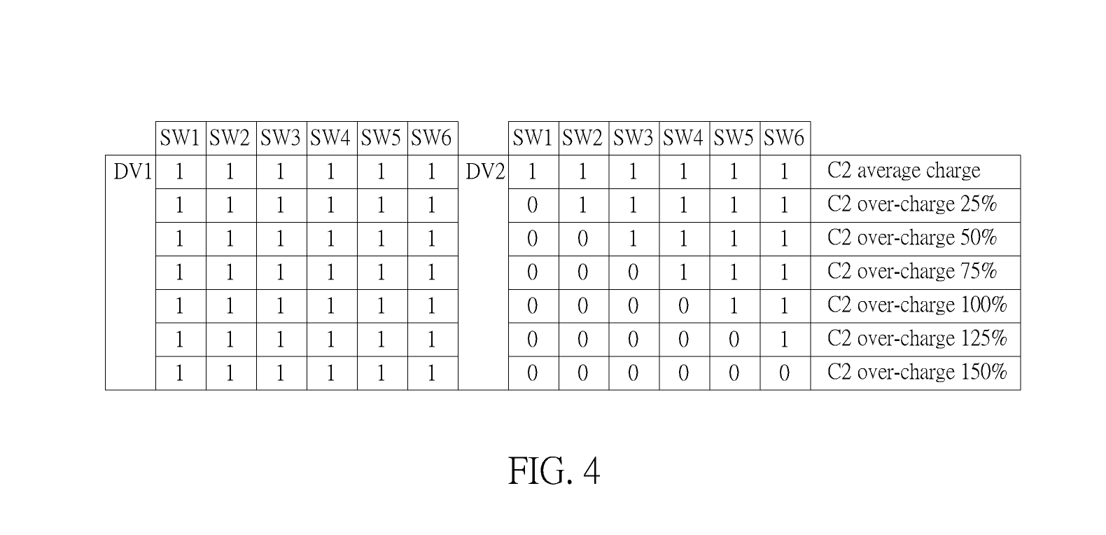

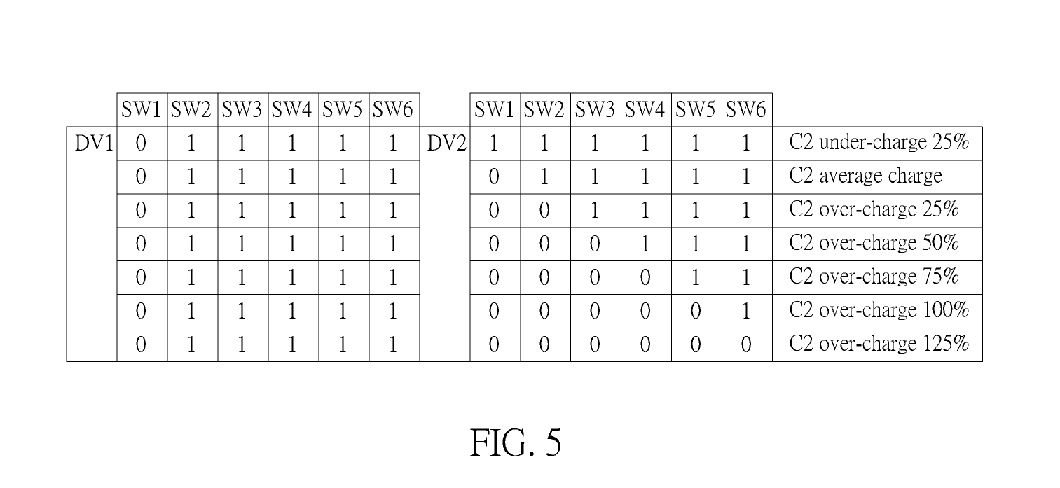

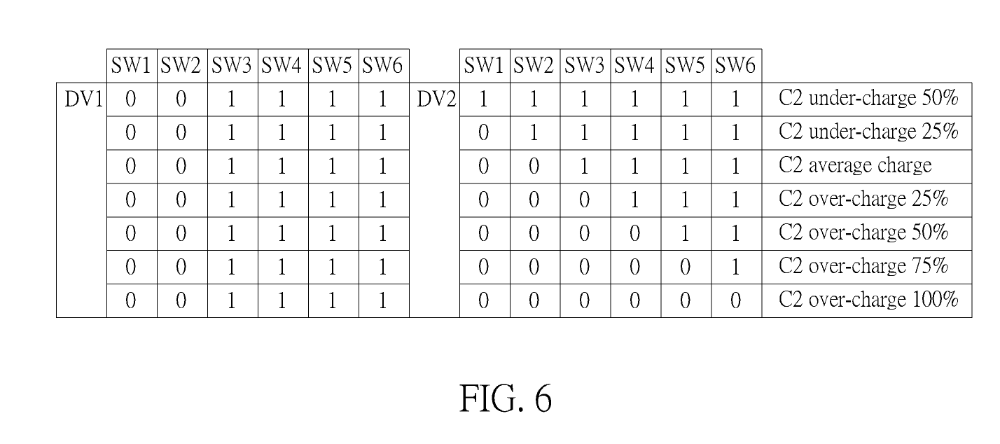

Please refer to FIGS. 4-6, which is diagrams illustrating the values of DV1 and DV2 and the corresponding charge state of the battery cell C2 according to one embodiment of the present invention. As shown in FIGS. 4-6, it is not suitable to design a circuit to implement the tables, especially when quantity of the battery cells is increased and/or a smaller tolerance factor is required (i.e. more reference voltages to be compared). Therefore, the embodiment concludes a method to use some simple calculation steps to determine the state of the battery cell C2 and how serious the overcharge state is. In detail, first, the calculation unit 328 calculates a summation of the six comparison results DV1 and a summation of the six comparison results DV2, that is: Sum(DV1)=b(SW1)+b(SW2)+b(SW3)+b(SW4)+b(SW5)+b(SW6), and Sum(DV2)=b(SW1)+b(SW2)+b(SW3)+b(SW4)+b(SW5)+b(SW6), where b(SW1)−b(SW6) are the comparison results while the switches SW1-SW6 is on, respectively. Then, the calculation circuit 328 subtracts Sum(DV2) from Sum(DV1) to generate a difference value D, and the difference value D can be used to determine the charge state of the battery cell C2 and its over-charge degree as follows: if D=0, the battery cell C2 is not over-charged; if D>0, the battery cell C2 is over-charged, and the over-charge degree is |Sum(DV1)−Sum(DV2)|*25% ; and if D<0, the battery cell C2 is under-charged, and the under-charge degree is |Sum(DV1)−Sum(DV2)|*25%.

Similarly, the charge states of the battery cells C3 and C4 can be determined based on the embodiments mentioned above.

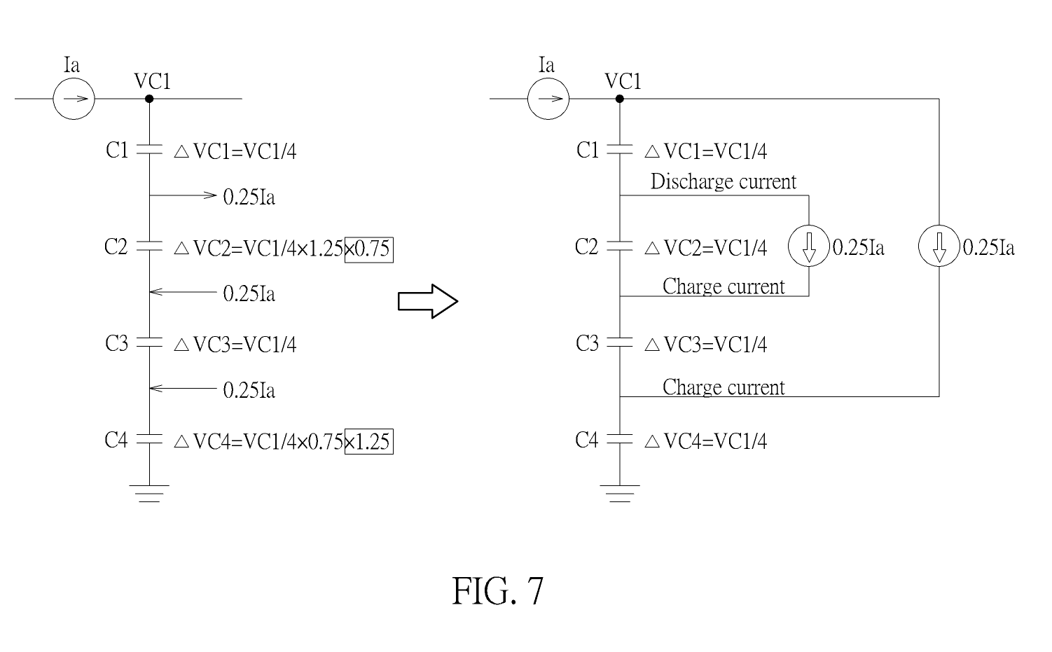

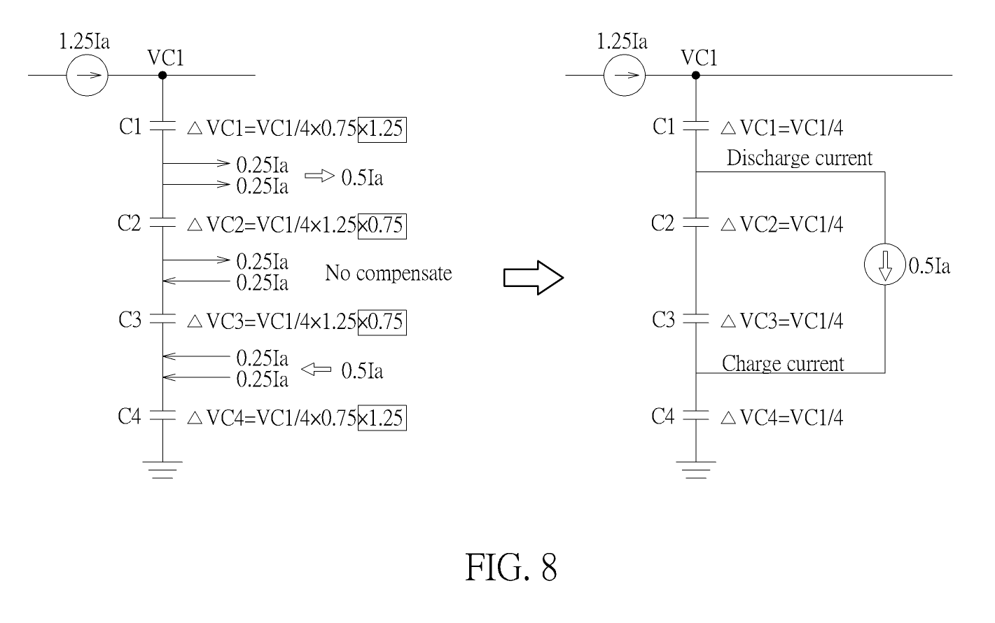

After the detecting circuit 320 determines the charge states of the battery cells, the detecting circuit 320 outputs an determining result Dout to the control circuit 330, and the control circuit 330 may perform some compensation mechanisms to avoid or alleviate the over-charge situation of the battery cells according to the charge states and the programmed tolerance factors of the battery cells C1-C4 (the tolerance factors may not all the same). In one embodiment, each of the battery cells C1-C4 has its own programmed tolerance factor, the charge current of the battery cell is adjusted only when the over-charge situation of the battery cell is greater than its tolerance factor. In this embodiment, to decrease the power consumption, the control circuit 330 applies a current reuse mechanism to solve the over-charge problem as shown in FIG. 7 and FIG. 8.

Please refer to FIG. 7, which is a current reuse method according to one embodiment of the present invention. In FIG. 7, it is assumed that the battery cell C2 is over-charged 25%, and the battery cell C4 is under-charged 25%, where the symbols ΔVC1, ΔVC2, ΔVC3, ΔVC4 are the cross voltages of the battery cells C1-C4, respectively. As shown in FIG. 7, to avoid or alleviate the over-charge situation of the battery cell C2, the control circuit 330 extracts a current from the charge node of the battery cell C2, where the extracted current is equal to 0.25*Ia. Therefore, because the current flowing into the battery cell C2 is decreased, the over-charge situation of the battery cell C2 can be improved.

Furthermore, because the battery cell C3 is not over-charged or under-charged, the extracted current from the charge node of the battery cell feeds into the charge node of the battery cell C3, to maintain the current flowing into the battery cell C3. In addition, another current source is provided to feed an extra current (0.25*Ia) into the battery cell C4, to improve the under-charge situation of the battery cell C4.

Please refer to FIG. 8, which is a current reuse method according to one embodiment of the present invention. In FIG. 8, it is assumed that the battery cells C1 and C4 are under-charged 25%, and the battery cells C2 and C2 are over-charged 25%, where the symbols ΔVC1, ΔVC2, ΔVC3, ΔVC4 are the cross voltages of the battery cells C1-C4, respectively. As shown in FIG. 8, because the battery cell C1 is under-charged 25%, so the control circuit 330 directly increases the supply current Ia to be “1.25*Ia”. Then, because the battery cell C1 is over-charged 25%, the control circuit 330 extracts a current from the charge node of the battery cell C2, where the extracted current is equal to 0.5*Ia. Therefore, because the current flowing into the battery cell C2 is decreased, the over-charge situation of the battery cell C2 can be improved.

Furthermore, the battery cell C3 does not need to be compensated, and the battery cell C4 needs an additional current (0.5*Ia) to improve the under-charge situation. Therefore, the extracted current (0.5*Ia) from the charge node of the battery cell C2 is totally fed into the charge node of the battery cell C4, and there is no need to use the additional current source.

By using the methods shown in FIGS. 7 and 8, the extracted current can be reused to save the power consumption, while the over-charge and under-charge states of the battery cells are improved.

In addition, the current extraction and the current feeding operations can be implemented by many current sources connected in parallel, and one or more current sources can be selected to obtain the required current value.

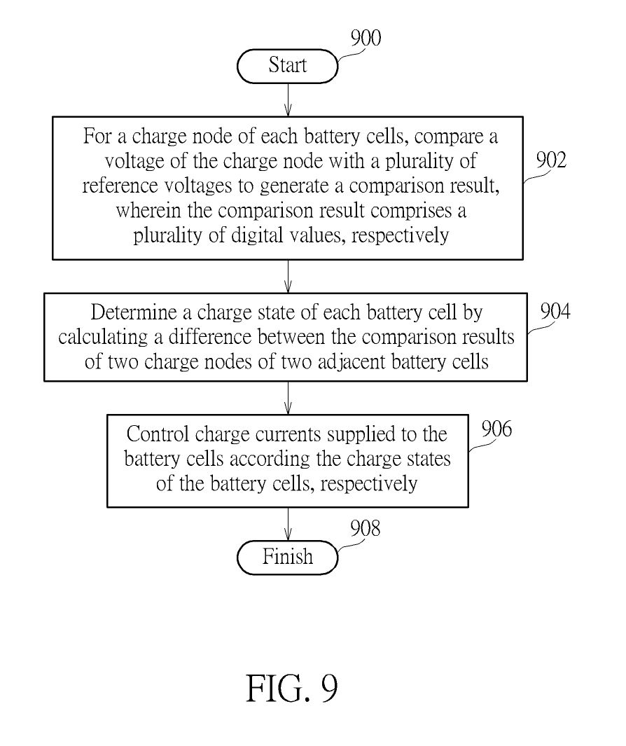

Please refer to FIG. 9, which is a flowchart of a method for controlling charge states of a plurality of battery cells connected in series according to one embodiment of the present invention. Referring to the above-mentioned disclosure, the flow is described as follows.

Step 900: the flow starts.

Step 902: for a charge node of each battery cells, compare a voltage of the charge node with a plurality of reference voltages to generate a comparison result, wherein the comparison result comprises a plurality of digital values, respectively.

Step 904: determine a charge state of each battery cell by calculating a difference between the comparison results of two charge nodes of two adjacent battery cells.

Step 906: control charge currents supplied to the battery cells according the charge states of the battery cells, respectively.

Step 908: the flow finishes.

Briefly summarized, in a method for controlling charge states of battery cells and associated charge system, the charge states of the battery cells can be determined based on a simple circuit structure, and this simple circuit structure has a lower power consumption. In addition, a current reuse technique is applied to the charge system to save the power consumption.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for controlling charge states of a plurality of battery cells connected in series, comprising:
for a charge node of each battery cells, comparing a voltage of the charge node with a plurality of reference voltages to generate a comparison result, wherein the comparison result comprises a plurality of digital values, respectively;
determining a charge state of each battery cell according to a summation of the plurality of digital values; and
controlling charge currents supplied to the battery cells according the charge states of the battery cells and programmable tolerance factors of the battery cells, respectively, wherein the programmable tolerance factors of the battery cells are not all the same.

2. The method of claim 1, wherein the plurality of battery cells comprises a first battery cell and a second battery cell connected in series, and the second battery cell is coupled to a supply voltage via the first battery cell, and the step of determining the charge state of each battery cell comprises:
subtracting a summation of the digital values corresponding to the charge node of the second battery cell from a summation of the digital values corresponding to the charge node of the first battery cell to generate a difference value; and
determining the charge state of second battery cell according to the difference value.

3. The method of claim 2, wherein the step of determining the charge state of the second battery cell comprises:
when the difference value is zero, determining that the first battery cell and the second battery cell are balanced charged;
when the different value is greater than zero, determining that the second battery cell is over-charged; and
when the different value is less than zero, determining that the second battery cell is under-charged.

4. The method of claim 1, wherein the step of controlling the charge currents supplied to the battery cells comprises:
when a first battery cell of the plurality of battery cells is determined to have an over-charge state, extracting an extracted current from the charge node of the first battery cell to lower the current flowing to the first battery cell.

5. The method of claim 4, further comprising:
when a second battery cell of the plurality of battery cells is determined to have an under-charge state, feeding the extracted current from the charge node of the first battery cell to the charge node of the second battery cell, to increase the current flowing into the second battery cell.

6. The method of claim 1, wherein the step of controlling the charge currents supplied to the battery cells comprises:
when a specific battery cell is determined to have an under-charge state, feeding an extra current to the charge node of the specific battery cell to increase the current flowing into the specific battery cell.

7. The method of claim 1, wherein the extra current is from the charge node of one of the other battery cells, or the extra current is from a current source.

8. The method of claim 1, wherein the determining step and the controlling step are triggered to be executed while the battery cells are charged and a voltage level of the charge node of a leading battery cell reaches a threshold voltage.

9. A method for controlling charge states of a plurality of battery cells connected in series, comprising:
determining a charge state of each battery cell;
when a first battery cell of the plurality of battery cells is determined to have an over-charge state, extracting an extracted current from a charge node of the first battery cell to lower a current flowing into the first battery cell; and
when a second battery cell of the plurality of battery cells is determined to have an under-charge state, feeding the extracted current from the charge node of the first battery cell to a charge node of the second battery cell, to increase a current flowing into the second battery cell.

10. The method of claim 9, further comprising:
when a third battery cell of the plurality of battery cells is determined to have the under-charge state, feeding an extra current to a charge node of the third battery cell to increase a current flowing into the third battery cell.

11. The method of claim 10, wherein the extra current is from a charge node of one of the other battery cells, or the extra current is from a current source.

12. The method of claim 9, further comprising:
when a third battery cell of the plurality of battery cells is determined to have the over-charge state, guiding a portion of a current flowing into the first battery cell to a ground, to lower the current flowing into the third battery cell.

13. The method of claim 9, further comprising:
when a leading battery cell of the plurality of battery cells is determined to have an over-charge state, directly increasing a supply current for the plurality of battery cells.

14. The method of claim 9, wherein the determining step is triggered to be executed while the battery cells are charged and a voltage level of a charge node of a leading battery cell reaches a threshold voltage.

15. A charge system, comprising:
a plurality of battery cells connected in series;
a detecting circuit, coupled to the plurality of battery cells, wherein for a charge node of each battery cells, the detecting circuit compares a voltage of the charge node with a plurality of reference voltages to generate a comparison result, wherein the comparison result comprises a plurality of digital values, respectively; and the detecting circuit further determines a charge state of each battery cell by calculating a difference between the comparison results of two charge nodes of two adjacent battery cells; and
a control circuit, coupled to the detecting circuit, for controlling charge currents supplied to the battery cells according the charge states of the battery cells, respectively.

16. The charge system of claim 15, wherein the comparison result is a summation of the plurality of digital values.

17. The method of claim 16, wherein the plurality of battery cells comprises a first battery cell and a second battery cell connected in series, and the second battery cell is coupled to a supply voltage via the first battery cell, and the detecting circuit subtracts the comparison result of the charge node of the second battery cell from the comparison result of the charge node of the first battery cell to generate a difference value, and the detecting circuit determines the charge state of second battery cell according to the difference value.

18. The method of claim 17, wherein when the difference value is zero, the detecting circuit determines that the first battery cell and the second battery cell are balanced charged; when the different value is greater than zero, the detecting circuit determines that the second battery cell is over-charged; and when the different value is less than zero, the detecting circuit determines that the second battery cell is under-charged.

19. The charge system of claim 15, wherein the plurality of battery cells are super-capacitors or ultra-capacitors.
